(19) United States
(12) Patent Application Publication
(10) Pub. No.: US 2016/0348888 A1
(43) Pub. Date: Dec. 1, 2016

(54) ILLUMINATING DECORATIVE BADGES

(71) Applicant: Michael Drews, Eugene, OR (US)

(72) Inventor: Michael Drews, Eugene, OR (US)

(21) Appl. No.: 14/726,328

(22) Filed: May 29, 2015

(51) Int. Cl. F21V 33/00; F21L 4/02; F21V 23/02; F21V 23/04; F21V 21/096

(52) U.S. Cl. CPC F21V 33/0008; F21V 23/04; F21V 21/0965; F21V 23/02; F21L 4/02; F21Y 2101/02

(57) ABSTRACT

Decorative badges are disclosed that removably attach to a user's clothes and include a team logo and an illuminating element that can be switched on or off. In some examples, the illuminating decorative badge includes a switch that automatically causes the illuminating element to light when the badge is attached to the user's clothes. In some further examples, the decorative badge allows the team logo and illuminating element to be swapped, so as to allow the decorative badge to be repurposed for a variety of sports teams. The decorative badge is typically round in shape, but can be fashioned in a variety of different shapes to suit the user's purposes.

### BACKGROUND

The present disclosure relates generally to decorative badges designed to be worn over clothing. In particular, decorative badges that possess an illuminating ring and have a center decorative disc that can be replaced are described.

Sports fans frequently desire to show support for their favorite teams. One of the ways dais support is shown is by the purchase and use of memorabilia of various kinds. Historically this memorabilia comprises hats, jackets, jerseys with team colors and a favorite player's number, other team-color themed apparel, foam novelty hands and head gear, as well as a variety of other items that are similarly team-themed. Fans will also often don makeup in their favorite team's colors to show their support in connection with memorabilia. Generally, any device that s a fan to unabashedly show their team spirit will be well received. There is, at present, few options for memorabilia that illuminates, which can make an exciting presence in a sports stadium or arena when lights are dimmed. Thus, there exists a need for sports fan memorabilia that illuminates. Examples of new and useful illuminating decorative badges relevant to the needs existing in the field are discussed below.

Disclosure addressing one or more of the identified existing needs is provided in the detailed description below. Examples of references relevant to illuminating decorative badges include U.S. Patent References D660,368, D660,370, D661,745, D662,146, D681,78, and D681,739. The complete disclosures of the above. patents and patent applications are herein incorporated by reference for all purposes.

### SUMMARY

The present disclosure is directed to a decorative badge that attaches to a user's clothes and includes a team logo and an illuminating element that can he switched on or off. In some examples, the illuminating decorative badge includes a switch that automatically causes the illuminating element to light when the badge is attached to the user's clothes. In some further examples, the decorative badge allows the team logo and illuminating element to be swapped, so as to allow the decorative badge to be repurposed for a variety of sports teams. The decorative badge is typically round in shape, but can be fashioned in a variety of different shapes to suit the user's purposes.

### BRIEF DESCRIPTION OF THE DRAWINGS

FIG. 1A is an exploded view of a first example of an illuminating decorative badge.

FIG. 1B is a perspective view of the illuminating decorative badge shown in FIG. 1A depicting the assembled badge in conjunction with the backing plate used to attach it through clothing.

FIGS. 2A-2C are perspective views of various implementations of the illuminating element of the illuminating decorative badge shown in FIGS. 1A and 1B.

FIGS. 3A-3C are overhead views of additional examples of alternative embodiments of illuminating decorative badges.

FIG. 4 is a front view of a preferred use of the illuminating decorative badge shown in FIGS. 1A and 1B.

### DETAILED DESCRIPTION

The disclosed illuminating decorative badges will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various illuminating decorative badges are Provided. Related features in the examples may be identical, similar, or dissimilar in different examples. For the sake of brevity, related features not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The disclosed illuminating decorative badge is designed to be removably attached to a user's clothes, and includes a switch that causes the badge to illuminate upon attachment. The basic design includes a center design element that may include team colors and/or a team logo, which is surrounded by the illuminating element. The illuminating element may also reflect the desired team's colors. The illuminating element and design element may be made removable so as to facilitate interchanging with other illuminating and design elements reflective of other teams, thereby enabling the device to be used for multiple sports teams.

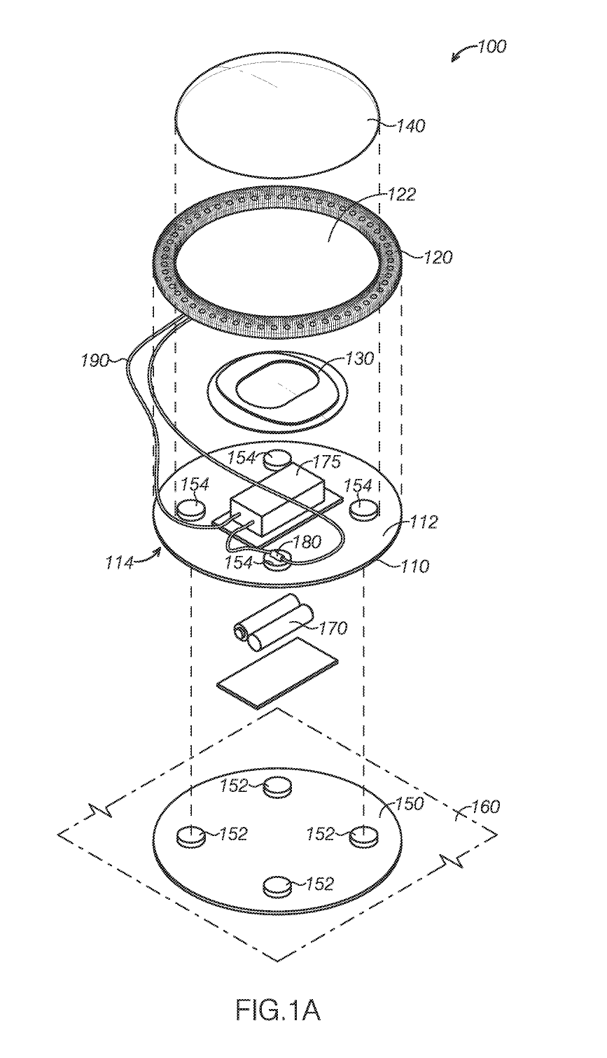

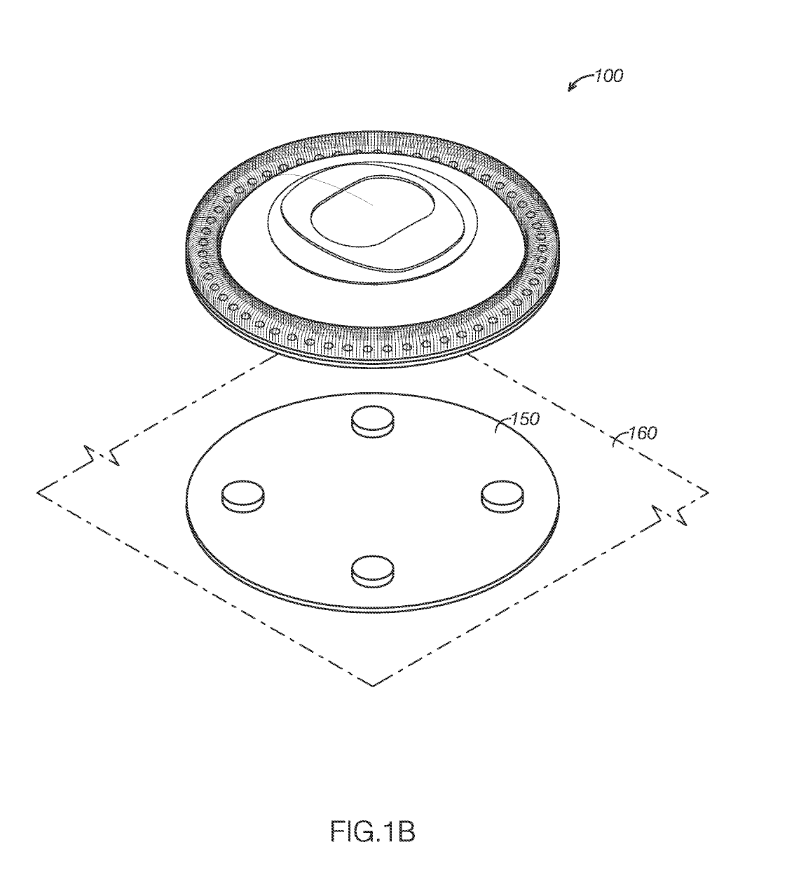

With reference to FIGS. 1A-4, a first example of an illuminating decorative badge, badge 100, will now be described. Badge 100 includes a housing 110, an illuminating element 120, a design element 130, a transparent cover 140, a backing plate 150, a power source 170, and switch 180. In other examples, the badge 100 includes additional or alternative features, such as a radio receiver integrated into power module 175 that can flash the illuminating element 120 of the badge 100 upon receipt of an appropriate radio signal.

As can be seen in FIG. 1A, housing 110 includes a display surface 112 and an opposing lower surface 114. Mounted either atop the display surface 112, upon opposing lower surface 114, or through housing 110 so as to sit flush with the opposing lower surface 114 are a plurality of magnetically attractive means that are implemented as depicted as buttons 154, that are comprised of ferromagnetic material, such as iron, nickel, cobalt, alloys of these metals, or any other compound that exhibits magnetic attractive behavior in the presence of a magnetic field. The number and position of these buttons correspond to the number and position of magnets 152 that are mounted on backing plate 150. Magnets 152 can be mounted on top of backing plate 150 or flush with either or both of its surfaces. Alternatively, buttons 154 could be replaced with a strip or ring of ferromagnetic material. Buttons 154 could also be magnets, arranged with complementary poles to magnets 152. Likewise, the magnets 152 on backing plate 150 can alternatively be implemented by employing strips or a ring of magnetic material. In yet a further implementation, buttons 154 can be done away with by implementing housing 110 itself out of ferromagnetic material, so that magnets 152 are attracted to housing 110. The magnets 152 and buttons 154 must be of sufficient strength so as to allow backing plate 150 to magnetically secure to housing 110 through clothing layer 160, to hold badge 100 in place on the clothing layer 160 without slipping.

It will be understood by a person skilled in the relevant art that the number and position of magnets 152 and buttons 154 are for example purposes only, and are not meant to be limiting. The ability of magnets 152 and buttons 154 to secure badge 100 in place on the clothing layer 160 without slippage depends on whether clothing layer 160 possesses any properties that may interfere with the magnetic attraction between magnets 152 and buttons 154. Bulky garments may require stronger or a greater number of magnets 152 and a corresponding increase in the number of buttons 154. Likewise, garments that are magnetically impermeable may interfere with the ability of magnets 152 to adhere to buttons 154. For garments that are incompatible with magnetic attraction, magnets 152 and buttons 154 can be replaced with alternative attachment means, such as a pin and clasp as has been long used with decorative pin buttons that are well-known in the prior art.

Also mounted atop the display surface 112 are the illuminating element 120, which is preferably mounted so as to be adjacent to the perimeter of housing 110, design element 130, which is ideally positioned approximately centrally upon the display surface 112, and the transparent cover 140, which sits atop the design element 130. Design element 130 includes the logo and/or colors of the user's selected sports team. The transparent cover 140 and design element 130 can be made removable so that the user of the badge 100 can swap out the design element 130 with a design element 130 implementing a different sports team's colors and/or logo. The transparent cover 140 can be made removable by a variety of methods, e.g. threaded into the side of the illuminating element 120, held in place by snapping under illuminating element 120, which in turn can be removed by unscrewing or unlatching from the housing 110, thereby freeing up the transparent cover 140, or any other method allowing the transparent cover 140 to be removed and replaced without damage to either it or the other components of badge 100.

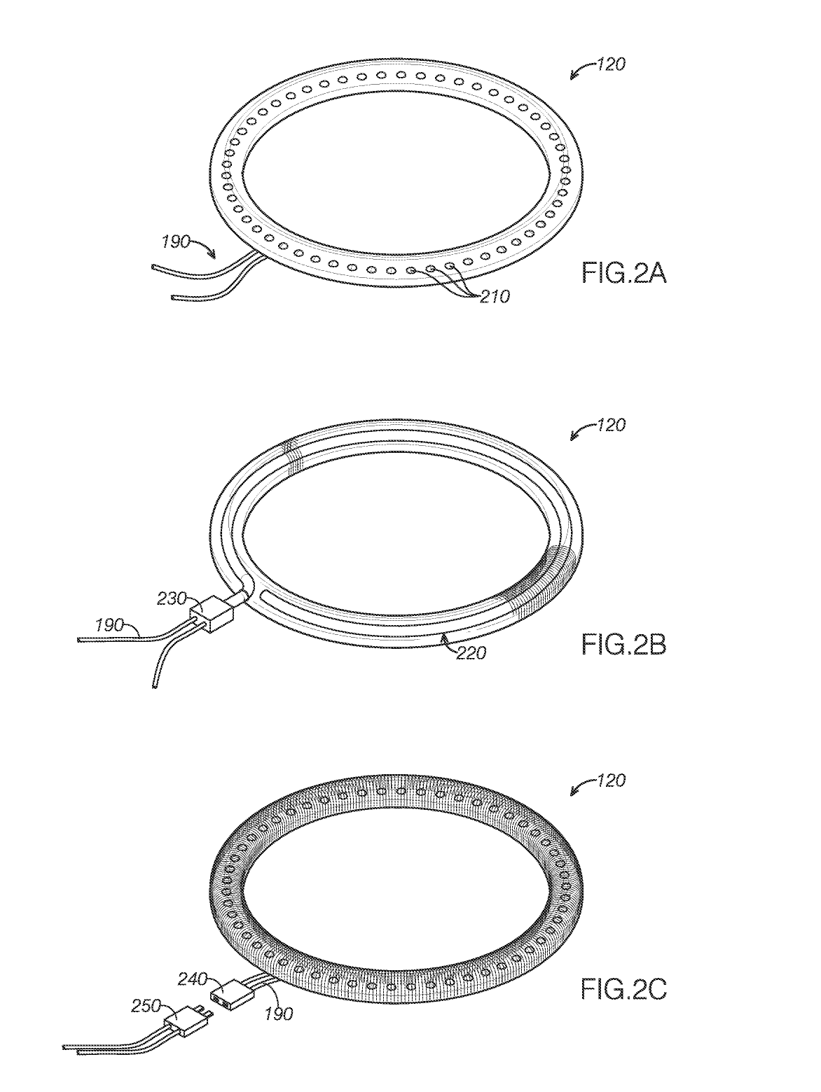

In the example shown in FIGS. 2A through 2C, illuminating element 120 is implemented as a ring that preferably is mounted so as to be adjacent to the perimeter of the housing 110. As a ring, illuminating element 120 possesses a hollow center 122, so as to surround the design element 130 when placed upon the center of the housing 110. In one possible implementation of illuminating element 120, the element is comprised of a strip of numerous individual lights 210. Lights 210 are preferably light emitting diodes (LEDs), which have the advantages of low heat and power consumption, enabling a smaller power source and longer run time. Another possible implementation of illuminating element 120 is with a fiber optic cable 220, which in turn is illuminated with an end lamp 230. The person skilled in the relevant art will appreciate that these two possible implementations are examples only, and the illuminating element 120 can be implemented using any means now known or later devised for providing a selectively illuminated ring of light, such as OLEDs (organic LEDs), cold cathode lighting, fluorescent lighting, incandescent lamps, etc., or any other suitable lightweight battery-powered light source.

Illuminating element 120 may be manufactured in a variety of colors that can reflect the colors of the user's selected sports team. As such, the color or colors of illuminating element 120 can reflect or complement the colors of design element 130. The illuminating element 120 can be implemented in a single color, or with multiple colors in a variety of patterns. As shown in FIG. 2C, the illuminating element 120 can be made removable by equipping it with a plug 250 and receptacle 240, allowing the illuminating element 120 to be detached from the badge 100, and a different illuminating element 120 installed.

The illuminating element 120 is Dowered via power leads 190. Power leads 190 are in turn connected to the power source 190 via switch 180 and power module 175. In FIG. 1A, power source 190 is depicted as a pair of cylindrical batteries; however, a person skilled in the prior art will appreciate that any power source capable of outputting sufficient voltage and current to illuminate the selected illuminating element 120 may be utilized. Some examples include button cells, rechargeable cells, super capacitors, an external battery pack, or any other portable power source now known or later devised. Power module 175 can be a simple box and contact set as is well known in the art that can accept the power source 170. Power module 175 may equipped with a radio receiver that is capable modulating the power from the power source 170 upon receipt of an appropriate radio signal, such as causing the illuminating element 120 to flash temporarily, or switch or modulate color if the badge 100 is equipped with an illuminating element 120 capable of outputting changing or multiple colors, such as color-selectable LEDs. The radio receiver is preferably a Bluetooth receiver that can be directed by any appropriate Bluetooth-equipped device, such as a smartphone or computer. Alternatively, the radio receiver equipped power module 175 may be able to receive signals from a dedicated remote control.

Switch 180 is preferably implemented as a magnetically-sensitive switch that causes the illuminating element 120 to be lit when the magnets 152 are brought in proximity, such as when the badge 100 in affixed to the user's clothes. Where buttons 154 are implemented as magnets that correspond to magnets 152, the switch 180 may need to be relocated so as to not be affected by buttons 154, or switch 180 may be located in a position corresponding to a magnet 152 in place of a corresponding button 154. Alternatively, switch 180 can be implemented as a manually operated switch that can be toggled from the opposing lower surface 114.

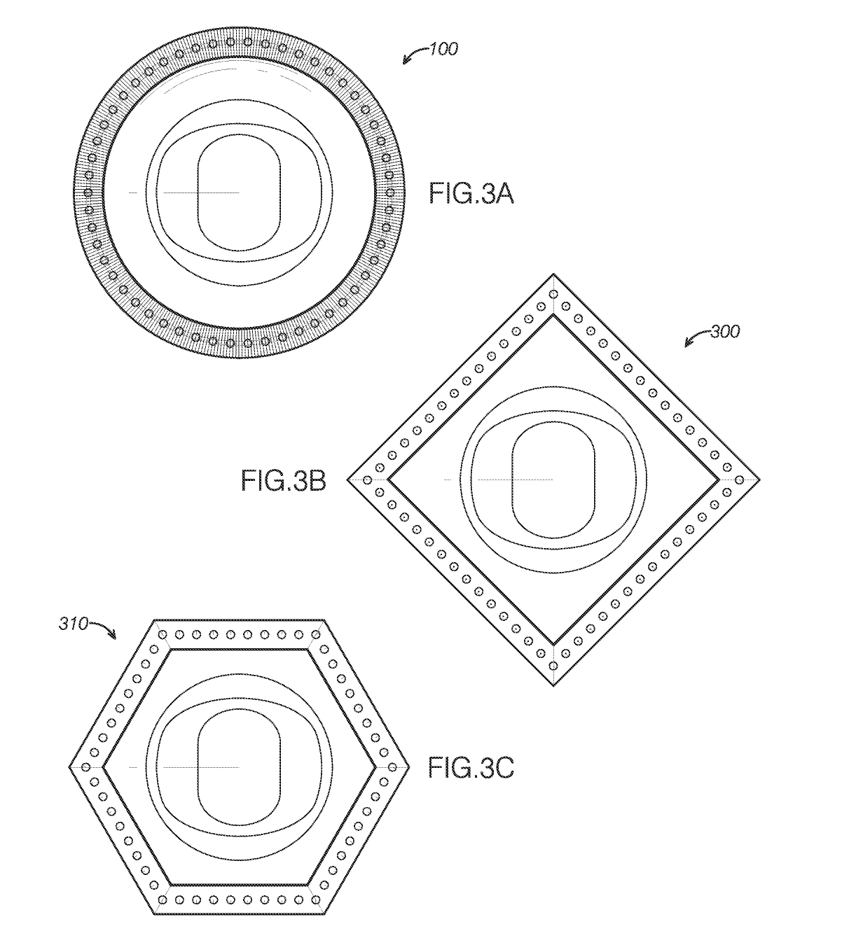

Turning attention to FIGS. 3A to 3C, additional possible examples of illuminating decorative badges will now be described. Badges 300 and 310 include identical features to badge 100. Thus, for the sake of brevity, each feature of badges 300 and 310 will not be redundantly explained. Badge 300 depicts a badge implemented in a square or diamond shape, and badge 310 depicts a badge implemented in a hexagonal shape. It should be appreciated that the illuminating decorative badges disclosed herein can be manufactured in a multitude of shapes while still practicing the invention, including shapes that are potentially relevant to individual sports teams.

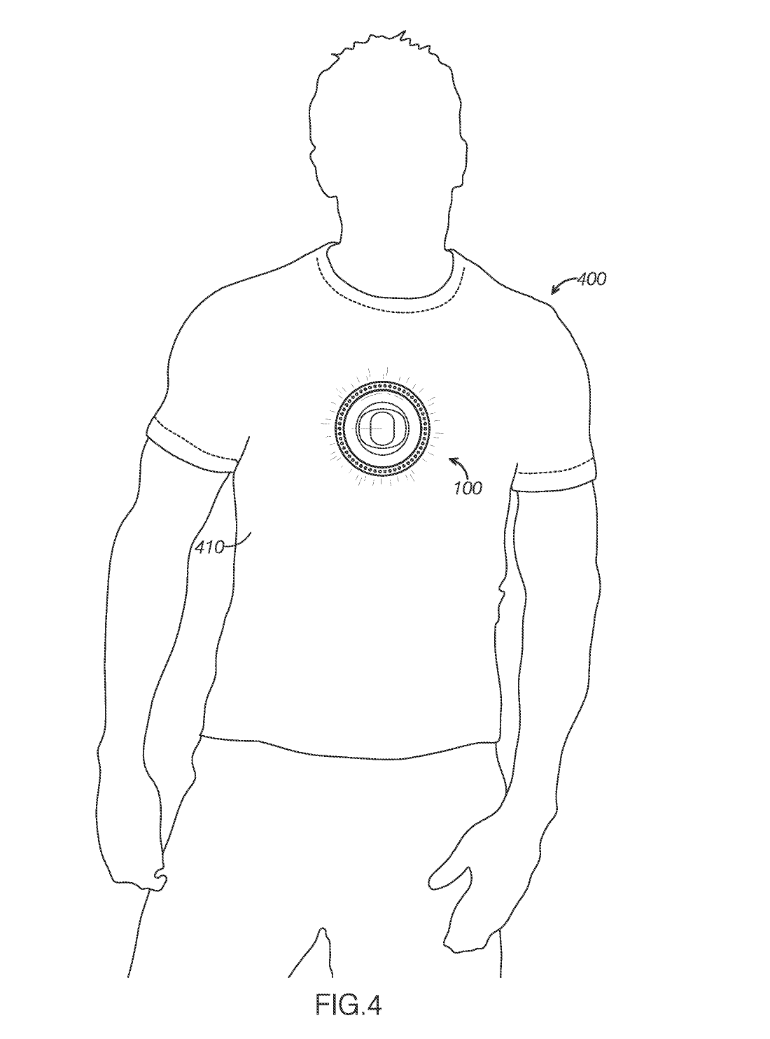

FIG. 4 demonstrates the badge 100 in use. User 400 attaches badge 100 to his shirt 410 by inserting the backing plate 150 underneath the shirt 410, and then bringing badge 100 into pros mite. The magnets 152 embedded into backing plate 150 are attracted to the buttons 154 and securely affix the badge 100 to the shirt 410. Simultaneously, at least one of the magnets 152 interacts with the switch 180, causing the illuminating element 120 to be energized by the power source 170 and thus to light.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all hovel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A decorative badge, comprising:
a housing possessing a display surface and an opposing lower surface, comprising:
an illuminating element disposed upon the outer perimeter of the housing so as to be visible when viewed from the display surface when illuminated, capable of being selectively illuminated, and possessing a hollow center; and
a design element disposed upon the center of the housing so as to be visible when viewed from the display surface and further sized so as to fit and disposed within the hollow center of the illuminating element;
a substantially transparent cover disposed over the display surface of the housing and configured to fit within the hollow center of the illuminating element and overlay the design element;
a power source accessible from the lower surface of the housing, capable of illuminating the illuminating element;
a means for selectively controlling the illumination of the illuminating element by the power source; and
a means for attaching the appliance to a wearer's clothes so that the display surface is visible.

2. The decorative badge of claim 1, wherein the substantially transparent cover and design element are removably affixed to the housing so that the design element is accessible for removal and replacement.

3. The decorative badge of claim 1, wherein the means for attaching the appliance to a wearer's clothes is comprised of a plate possessing a plurality of magnets, the plurality of magnets corresponding to one or more magnetically attractive means affixed to the housing.

4. The decorative badge of claim 2, wherein the means for selectively controlling the illuminating element by the power source comprises a switch that turns on the illuminating element when the plate is placed in proximity to the lower surface of the housing.

5. The decorative badge of claim 4, wherein the switch is a switch that is responsive to the presence of a magnetic field.

6. The decorative badge of claim 2, wherein the plurality of magnets and one or more magnetically attractive means are arranged so that the plate magnetically adheres to the lower surface of the housing in a single orientation.

7. The decorative badge of claim 1, wherein the power source is comprises of one or more batteries.

8. The decorative badge of claim 1, wherein the housing is substantially round in shape.

9. The decorative badge of claim 8, wherein the transparent cover is substantially dome shaped.

10. The decorative badge of claim 1, wherein the illuminating element is comprised of a plurality of light emitting diodes.

11. The decorative badge of claim 1, wherein the illuminating element is comprised of a fiber optic cable.

12. The decorative badge of claim 1, wherein the illuminating element is attached to the power source using a plug and matching receptacle enabling it to be removed and replaced.

13. The decorative badge of claim 1, wherein the means for selectively controlling the illumination of the illuminating element comprises a switch capable of being manually operated by a user of the decorative appliance.

14. The decorative badge of claim 1, further comprising a means for flashing the illuminating element one or more times in response to a received radio signal.

15. A decorative badge, comprising:
a backing plate possessing a plurality of magnets;
a housing with a back surface and opposing display surface;
a plurality of magnetically attractive buttons disposed adjacent to the back surface of the housing and corresponding to one or more of the plurality of magnets on the backing plate, so as to allow the decorative appliance to be removably affixed to an article of clothing by sandwiching a layer of the article of clothing between the backing plate and the housing;
an illuminating element disposed upon the display surface of the housing and adjacent to the perimeter of the housing, the illuminating element sized so as to leave substantially all of the display surface uncovered;
a design element disposed upon the display surface so as to be substantially centered upon the display surface and substantially encircled by the illuminating element;
a transparent cover disposed upon the display surface so as to overlay the design element, and sized so as to be substantially encircled by the illuminating element;
a power source disposed upon the housing and capable of illuminating the illuminating element; and
a switch that is connected to the power source and the illuminating element, and disposed upon the housing so as to cause the illuminating element to be automatically illuminated by the power source when the backing plate is brought in proximity to the housing.

16. The decorative badge of claim 15, wherein the illuminating element is comprised of a plurality of LEDs.

17. The decorative badge of claim 16, wherein the power source is comprised of one or more batteries.

18. The decorative badge of claim 17, wherein the transparent cover is removably affixed so as to allow the design element to be removed and replaced.

19. The decorative badge of claim 18, wherein the switch further comprises a means capable of receiving a radio signal, receipt of which will trigger the switch to flash the illuminating element one or more times before returning to a steadily illuminated state.

20. The decorative badge of claim 19, wherein the decorative badge is substantially circular in shape, and the transparent cover is substantially domed in shape.
